(19) United States
(12) Patent Application Publication
(10) Pub. No.: US 2005/0051170 A1
(43) Pub. Date: Mar. 10, 2005

(54) Wearable inhalation filter

(76) Inventor: Myung Hoe Koo, Rowland Heights, CA (US)

Correspondence Address: PARK & SUTTON LLP, 3255 WILSHIRE BLVD, SUITE 1110, LOS ANGELES, CA, 90010, US

(21) Appl. No.: 10/657,109

(22) Filed: Sep. 9, 2003

(51) Int. Cl. A62B 23/02

(52) U.S. Cl. 128/206.11

(57) ABSTRACT

A wearable inhalation filter for a user to wear in her or his nostrils is provided. The filter includes two nose rings that are inserted into the nostrils, and a bridge that connects the nose rings. The nose ring includes a filter assembly for filtering air being inhaled, and the length of the bridge between the two nose rings is adjustable. The filter assembly includes a filter web having a plurality of pores, the size of which is from 4 to 25 μ. The filter web protrudes from the nose ring, and is corrugated to give wider filter area and to ease breathing. The bridge can rotate with respect to the nose ring. The distance between the bridge and the nose ring can be adjusted.

### BACKGROUND OF THE INVENTION

The present invention relates to a wearable inhalation filter. More particularly, the invention relates to a wearable inhalation filter that can be inserted into the nostrils and filters or captures materials that may be harmful or cause allergy to human beings.

Many people suffer from inhalation difficulties due to allergy or asthma, etc. A nose ring has been used to widen nostrils to alleviate the inhalation problems. Active functions of the nose ring including filtering or capturing potentially harmful materials are desirable so that such materials should not enter into a human body.

### SUMMARY OF THE INVENTION

An object of the invention is to provide a wearable inhalation filter that can filter out harmful materials such as pollen or air pollution particles.

Another object of the invention is to provide a wearable inhalation filter that can capture or neutralize harmful materials such as germs.

Still another object of the invention is to provide a wearable inhalation filter that can adjust its dimensions to accommodate various sizes of noses.

To achieve the above-described objects, the invention provides a wearable inhalation filter for a user to wear in her or his nostrils. The filter includes two nose rings that are inserted into the nostrils, and a bridge that connects the nose rings. Each of the nose rings includes a filter assembly for filtering air being inhaled, and the length of the bridge between the two nose rings is adjustable.

The filter assembly includes a filter web, and the filter web includes a physical filter layer having a plurality of pores. The filter web may have a corrugated shape to increase filtering area. Preferably, the size of the pores is in a range from about 4 μ to about 25 μ. More preferably, the size is about 10 μ.

The filter web may protrude out of the nose ring to increase filtering area thereby easing breathing.

The filter webs for the two nose rings may be integrated into a single filter web to further increase filtering area.

The filter web may be provided in a form to wrap around the nose rings and the bridge.

The filter web may further include a chemical filter layer having active carbon.

The filter assembly further includes a filter ring that holds the filter web. The filter ring is detachably attached to the nose ring. The filter ring is received in a circular groove provided on the nose ring.

The filter assembly further includes one or more mesh layers that are adjacent to the filter web. The mesh layers are plated with silver.

The bridge has two end connectors and a bridge body between the two end connectors. The end connector connects the bridge body to the nose ring. The end connector is rotatably attached to the nose ring. The end connector can adjust its length between the nose ring and the bridge body. The end connector includes a plurality of circular teeth along the length of the connector, and the nose ring includes a hole and the hole includes a circular projection. Two adjacent circular teeth of the end connector engage with the circular projection of the nose ring.

The length of the bridge body is adjustable. The bridge body includes a first bar and a second bar, and the second bar includes a slide hole into which the first bar can slide. The first bar includes a length adjusting projection, and the slide hole includes a plurality of length adjusting holes. The length adjusting projection engages with one of the length adjusting holes.

The nose ring is made of flexible material including silicone. The nose ring further includes a plurality of breath holes.

The filter may further include two holding members that partially surround the nose rings.

The present invention is an improvement over the inventor's U.S. Pat. No. 6,572,634. In addition to the functions of '634, the present invention helps to prevent nasal allergies.

The advantages of the present invention are numerous in that: (1) allergic or unhealthy particles, such as pollen, hair of pets, fine dust and ticks, that exist in the air being inhaled cannot get into inside of the nose; (2) the filter can be worn suitably and comfortably by the dimensional adjustability and flexibility; (3) the filter provides sterilization effect in addition to physical filtering effects; (4) the filter can be economically produced; and (5) the filter is provided in a compact size.

Although the present invention is briefly summarized, the fuller understanding of the invention can be obtained by the following drawings, detailed description and appended claims.

### BRIEF DESCRIPTION OF THE DRAWINGS

These and other features, aspects and advantages of the present invention will become better understood with reference to the accompanying drawings, wherein:

FIG. 1 is an illustrative perspective view showing a wearable inhalation filter according to the present invention is placed in the nostrils of a user;

FIG. 2 is an illustrative perspective view showing the wearable inhalation filter;

FIG. 3 is a cross-sectional view of a nose ring;

FIG. 4 is a front elevation view of a filter assembly;

FIG. 5 is a cross-sectional view taken along the line 5-5 in FIG. 4;

FIG. 6 is a view similar to FIG. 5 but with a different filter web;

FIG. 7 is a view similar to FIG. 5 but with another different filter web;

FIG. 8 is a view similar to FIG. 3 but with the filter assembly that occupies the whole available space in the nose ring;

FIG. 9 is a side elevation view showing the nose rings and a bridge;

FIG. 10 is a cross-sectional view taken along the line 10-10 in FIG. 9;

FIG. 11 is an enlarged cross-sectional view of the circle A in FIG. 9;

FIG. 12 is a view similar to FIG. 11 but shows different engaging parts;

FIG. 13 is an elevation view of the wearable inhalation filter showing filter assemblies that protrude outside of the nose rings;

FIG. 14 is an enlarged cross-sectional view of the circle B in FIG. 13;

FIG. 15 is a view similar to FIG. 13 but shows that a single filter assembly is provided for the nose rings;

FIG. 16 is an enlarged cross-sectional view of the circle C in FIG. 15; and

FIG. 17 is a view similar to FIG. 15 but shows that a single filter assembly encloses the nose rings and the bridge.

### DETAILED DESCRIPTION OF THE PREFERRED EMBODIMENTS

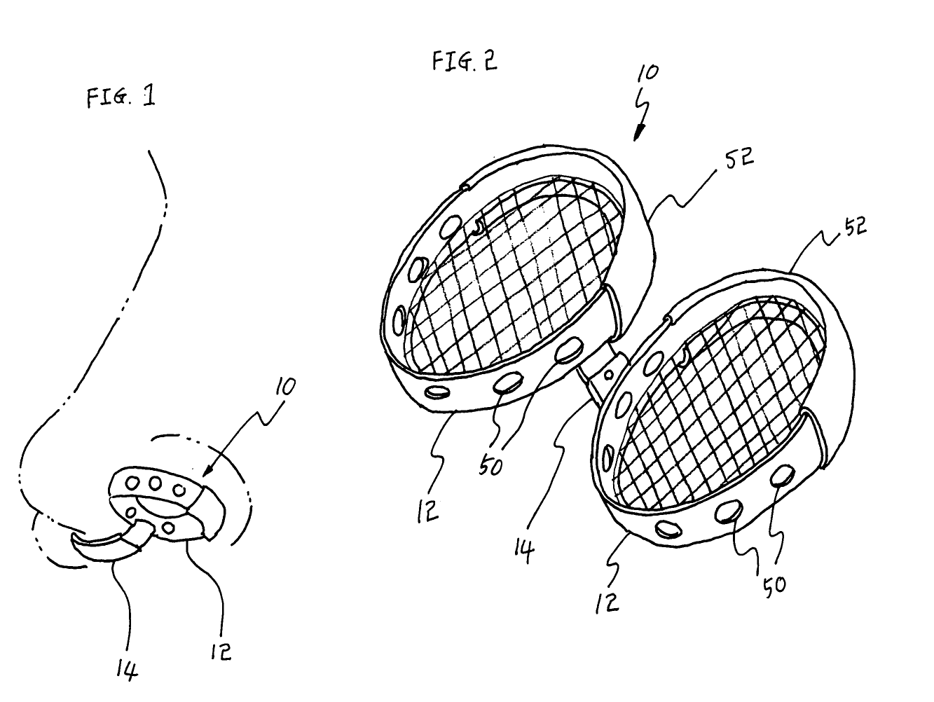

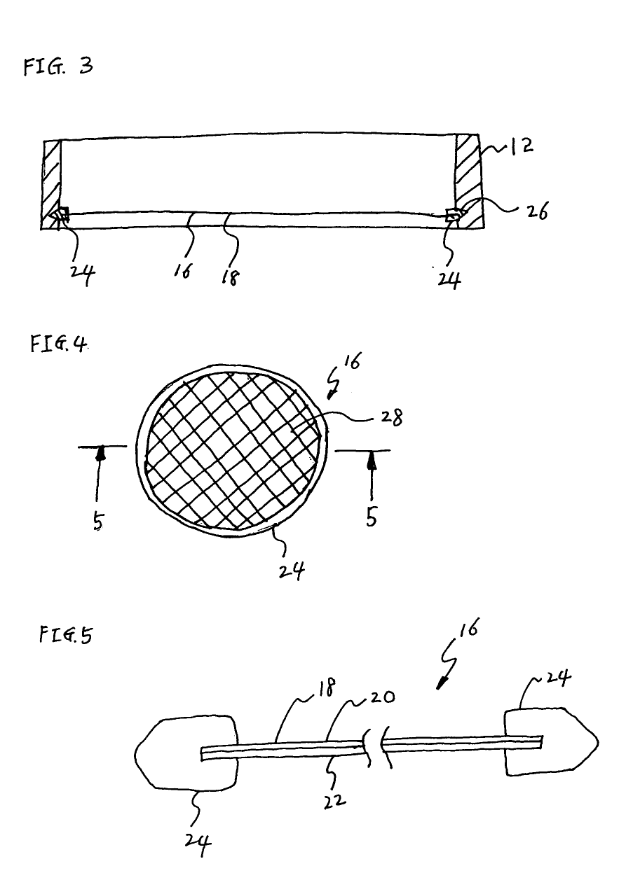

FIGS. 1 and 2 show a wearable inhalation filter 10 according to the present invention. The wearable inhalation filter 10 includes two nose rings 12 that are inserted into the nostrils of a user, and a bridge 14 that connects the nose rings 12. Each of the nose rings 12 includes a filter assembly 16 for filtering air being inhaled (Refer to FIG. 3). The length of the bridge 14 between the two nose rings 12, that is, the distance between the two nose rings 12 when the wearable inhalation filter 10 is worn by a user, is adjustable.

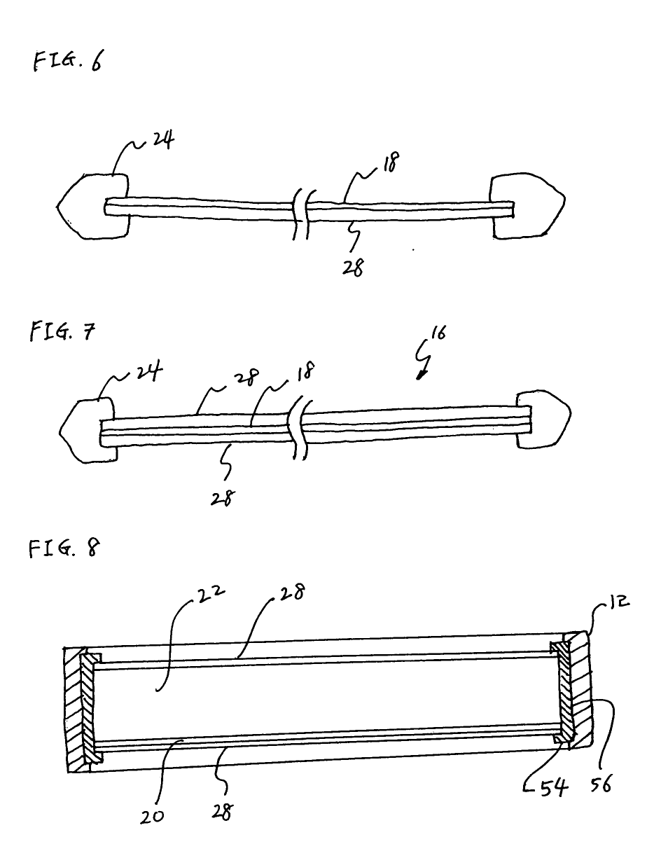

FIG. 3 shows the filter assembly 16 attached to the nose ring 12. FIGS. 4-8 show the filter assembly 16. As shown in FIG. 5, the filter assembly 16 includes a filter web 18. The filter web 18 includes a physical filter layer 20 that includes a plurality of pores. Preferably, the size of the pores is in a range from about 4 μto about 25 μ. More preferably, the size of the pores is about ten 10 μ (10000 nm). Since the size of pollen is about 5 μ (5000 nm)˜100 μ, the physical filter layer 20 can block pollen, other particles or tiny mites from entering into the nose.

The filter web 18 further includes a chemical filter layer 22. The chemical filter layer 22 includes active carbon thereby sterilizing or neutralizing potentially harmful materials such as germs.

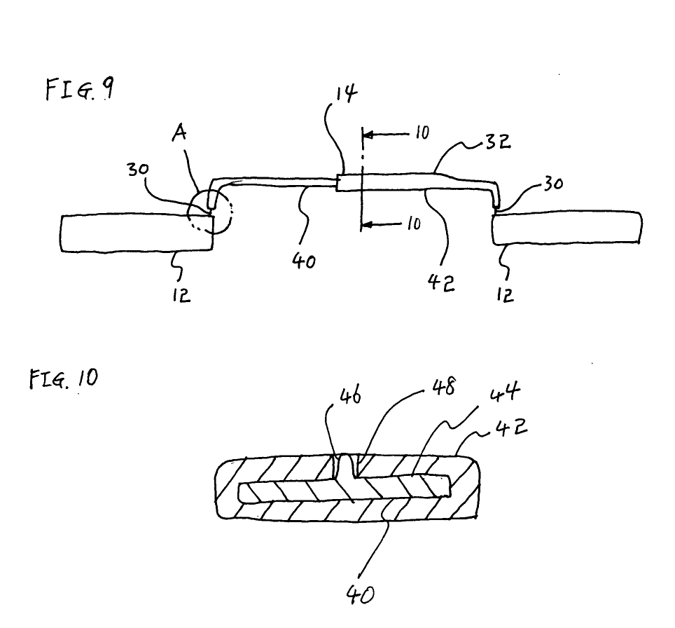

The filter assembly 16 further includes a filter ring 24. The filter ring 24 holds the filter web 18. The filter ring 24 is detachably attached to the nose ring 12. As shown in FIG. 3, the filter ring 24 is received in a circular groove 26 provided on the nose ring 12. The filter assembly 16 may further include one or more mesh layers 28 that are adjacent to the filter web 18 as shown in FIGS. 6, 7 and 8. The mesh layers 28 support the filter web 18. The mesh layers 28 are plated with silver to utilize anti-bacterial property of silver. FIG. 8 shows another filter ring 54 that utilizes substantially the whole width of the nose ring 12. The filter assembly 54 is received in a circular groove 56 provided in the nose ring 12. In this way, the thickness of the chemical filter layer 22 may be maximized to enhance filtering effect.

FIGS. 9-12 show the bridge 14. The bridge 14 has two end connectors 30 and a bridge body 32 between the two end connectors 30. The end connector 30 connects the bridge body 32 to the nose ring 12.

The end connector 30 is rotatably attached to the nose ring 12. The end connector 30 can adjust its length between the nose ring 12 and the bridge body 32. As shown in FIG. 11, the end connector 30 includes a plurality of circular teeth 34 along the length of the end connector 30. The nose ring 12 includes a hole 36 and the hole 36 includes a circular projection 38. Two adjacent circular teeth 34 engage with the circular projection 38. The end connector 30 can rotate within the hole 36 with the circular teeths 34 slidingly rotate with respect to the circular projection 38. The nose ring 12 and the end connector 30 are made of flexible materials, so that different circular teeth 34 may engage with the circular projection 38 as the end connector 30 is moved by a user further into or out of the hole 36. FIG. 12 shows bigger and rounded circular teeth 58 and a rounded circular projection 60.

The length of the bridge body 32 is adjustable. The bridge body 32 includes a first bar 40 and a second bar 42. The second bar 42 includes a slide hole 44 into which the first bar 40 can slide.

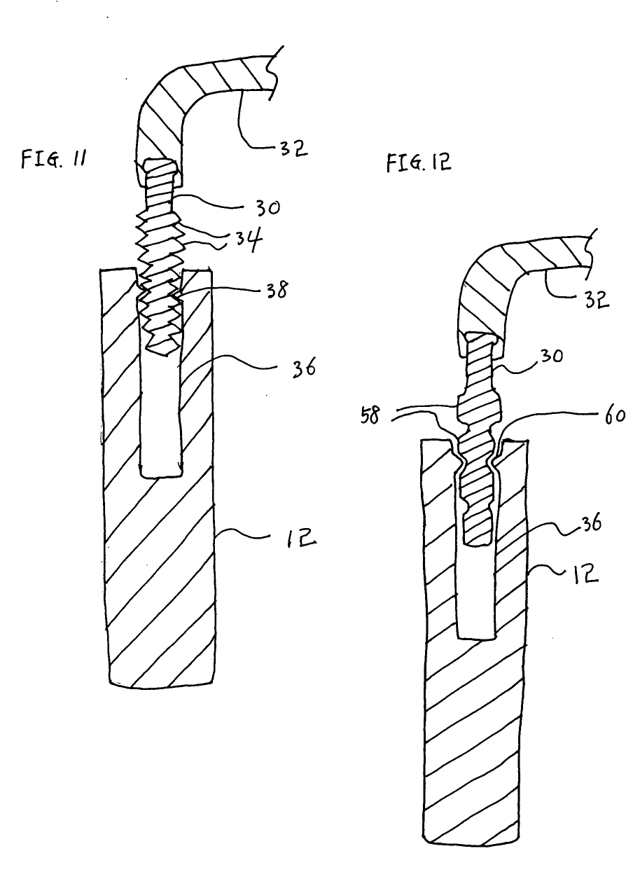

As shown in FIG. 10, the first bar 40 includes a length adjusting projection 46. The slide hole 44 of the second bar 42 includes a plurality of length adjusting hole 48 arranged along the length of the slide hole 44, and thus the second bar 42. The length adjusting projection 46 engages with one of the length adjusting holes 48 as the first bar 40 moves back and forth in the slide hole 44.

Therefore, relative position of the two nose rings 12 with each other can be adequately adjusted by the adjustable end connectors 30 and bridge body 32. Thus, the wearable inhalation filter 10 may be easily adapted to individual variations of nostrils' positions.

The nose ring 12 is made of flexible material including silicone. Thus, the nose ring 12 is comfortably fitted into a nostril due to its light weight and flexibility.

The nose ring 12 further includes a plurality of breath holes 50 as shown in FIG. 2. The breath holes 50 are arranged along the periphery of the nose ring 12. The breath holes 50 provide contact with air for portions of the nostril wall covered by the breath holes 50. Corresponding holes (not shown) may be provided on the filter ring 54.

The wearable inhalation filter 10 further comprises two holding members 52 as shown in FIG. 2. The holding member 52 partially surrounds the nose ring 12. The holding member 52 provides enforcement for the nose ring 12.

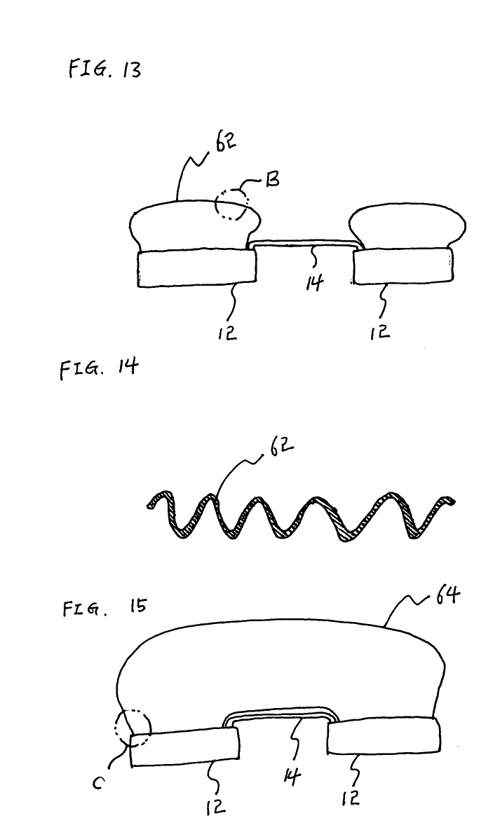

FIGS. 13˜17 show different embodiments of the filters. FIG. 13 shows that a filter web 62 protrudes out of the nose ring. In this way, the filter web 62 increases filtering area. Then finer pores may be used for a normal inhaling pressure of the human body.

FIG. 14 shows that the filter web 62 has a corrugated shape to further increase the filtering area.

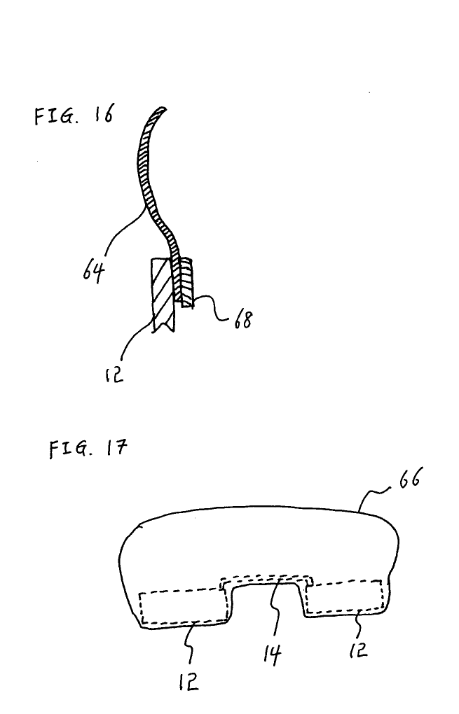

FIG. 15 shows that a single, integrated filter web 64 is provided for both of the nose rings 12. In this way, the filtering are is further increased, and the wearable inhalation filter can be produced more economically.

FIG. 16 shows how the filter web 64 is attached to the nose rings 12. A filter ring 68 is fixed to the filter web 64. The filter web 64 together with the filter ring 68 is detachably attached to the nose ring 12 by inserting the filter ring 68 into the nose ring 12.

FIG. 17 shows that a filter web 66 wraps around the nose rings 12 and the bridge 14. The wearable inhalation filter may be provided as a unit that includes the nose rings assembled with the bridge, and a filter web patch. After adjusting the bridge, the user simply wraps around the nose rings with the patch and wears the inhalation filter. The filter web is disposable separately from the nose rings and the bridge. The filter web may be made of non-woven cloth or fabric that has fine pores. Existing air cleaning filters that are used for air conditioners, etc. may also be used to make the filter web.

With the above construction, the wearable inhalation filter can actively remove harmful materials from inhalation air both physically and chemically. The wearable inhalation filter can be comfortably and conveniently worn by the dimensional adaptability of the bridge.

Although the invention has been described in considerable detail, other versions are possible by converting the aforementioned construction. Therefore, the scope of the invention shall not be limited by the specification specified above.

1. A wearable inhalation filter for a user to wear in her or his nostrils, comprising:
a) two nose rings that are inserted into the nostrils;
b) a bridge that connects the nose rings; wherein each of the nose rings comprises a filter assembly for filtering air being inhaled, and wherein the length of the bridge between the two nose rings is adjustable.

2. The wearable inhalation filter of claim 1, wherein the filter assembly comprises a filter web, wherein the filter web comprises a physical filter layer that comprises a plurality of pores.

3. The wearable inhalation filter of claim 2, wherein the filter web has a corrugated shape.

4. The wearable inhalation filter of claim 2, wherein the size of the pores is in a range from about four (4) μ to about twenty five (25) μ.

5. The wearable inhalation filter of claim 4, wherein the size of the pores is about ten (10) μ.

6. The wearable inhalation filter of claim 2, wherein the filter web protrudes out of the nose ring.

7. The wearable inhalation filter of claim 6, wherein the filter webs for the two nose rings are integrated into a single filter web.

8. The wearable inhalation filter of claim 2, wherein the filter web wraps around the nose rings and the bridge.

9. The wearable inhalation filter of claim 2, wherein the filter web further comprises a chemical filter layer.

10. The wearable inhalation filter of claim 9, wherein the chemical filter layer comprises active carbon.

11. The wearable inhalation filter of claim 2, wherein the filter assembly further comprises a filter ring, wherein the filter ring holds the filter web, wherein the filter ring is detachably attached to the nose ring.

12. The wearable inhalation filter of claim 11, wherein the filter ring is received in a circular groove provided on the nose ring.

13. The wearable inhalation filter of claim 2, wherein the filter assembly further comprises one or more mesh layers that are adjacent to the filter web.

14. The wearable inhalation filter of claim 13, wherein the mesh layers are plated with silver.

15. The wearable inhalation filter of claim 1, wherein the bridge has two end connectors and a bridge body between the two end connectors, and wherein the end connector connects the bridge body to the nose ring.

16. The wearable inhalation filter of claim 15, wherein the end connector is rotatably attached to the nose ring.

17. The wearable inhalation filter of claim 16, wherein the end connector can adjust its length between the nose ring and the bridge body.

18. The wearable inhalation filter of claim 17, wherein the end connector comprises a plurality of circular teeth along the length of the end connector, wherein the nose ring comprises a hole and the hole comprises a circular projection, and wherein the two adjacent circular teeth of the end connector engage with the circular projection of the nose ring.

19. The wearable inhalation filter of claim 15, wherein the length of the bridge body is adjustable.

20. The wearable inhalation filter of claim 19, wherein the bridge body comprises a first bar and a second bar, wherein the second bar comprises a slide hole into which the first bar can slide.

21. The wearable inhalation filter of claim 20, wherein the first bar comprises a length adjusting projection, wherein the slide hole comprises a plurality of length adjusting holes, and wherein the length adjusting projection engages with one of the length adjusting holes.

22. The wearable inhalation filter of claim 1, wherein the nose ring is made of flexible material.

23. The wearable inhalation filter of claim 22, wherein the nose ring is made of silicone.

24. The wearable inhalation filter of claim 1, wherein the nose ring further comprises a plurality of breath holes.

25. The wearable inhalation filter of claim 1, further comprising two holding members that partially surround the nose rings.
